(19) United States
(12) Patent Application Publication
(10) Pub. No.: US 2025/0080470 A1
(43) Pub. Date: Mar. 6, 2025

(54) NEGOTIATION FOR QUALITY OF SERVICE TRAFFIC CLASSIFICATION AND POLICY SETTING FOR UPLINK AND DOWNLINK FLOWS

(71) Applicant: Cisco Technology, Inc., San Jose, CA (US)

(72) Inventors: Binita GUPTA, San Diego, CA (US); Malcolm M. SMITH, Richardson, TX (US); Brian D. HART, Sunnyvale, CA (US); Venkataprasad CHIRREDDY, Milpitas, CA (US)

(21) Appl. No.: 18/818,919

(22) Filed: Aug. 29, 2024

Related U.S. Application Data
(60) Provisional application No. 63/580,582, filed on Sep. 5, 2023.

(51) Int. Cl. H04L 47/2441; H04W 28/02

(52) U.S. Cl. CPC H04L 47/2441; H04W 28/0268

(57) ABSTRACT

The present disclosure provides techniques for QoS negotiation for uplink and downlink traffic. A network device receives a Stream Classification Service (SCS) request from an associated station (STA). The SCS request comprises one or more sets of traffic class (TCLAS) information and a preferred traffic identifier (TID) value for a data flow transmitted between the STA and the network device. The network device determines a type of service of the data flow by analyzing the one or more sets of TCLAS information. The network device confirms that the type of service does not align with the preferred TID value under one or more defined network policies. In response to the confirmation, the network device sends an SCS response to the STA comprising adjustments of at least one of the one or more sets of TCLAS information or the preferred TID value to a new TID value.

### CROSS-REFERENCE TO RELATED APPLICATIONS

This application claims benefit of co-pending U.S. provisional patent application Ser. No. 63/580,582 filed Sep. 5, 2023. The aforementioned related patent application is herein incorporated by reference in its entirety.

### TECHNICAL FIELD

Embodiments presented in this disclosure generally relate to quality of service (QoS) negotiation. More specifically, embodiments disclosed herein relate to the negotiation of per-flow Stream Classification Service (SCS) policies for uplink and downlink data flows.

### BACKGROUND

In modern wireless networks, the efficient management of data traffic is important for maintaining optimal network performance and user satisfaction. The introduction of the IEEE 802.11 standards, including enhancements such as SCS, have provided tools for more targeted traffic management. However, the current SCS mechanism can only support the application of broad policies that fail to account for the dynamic and varied nature of individual data flows. More specifically, the existing SCS framework lacks a mechanism for an access point (AP) to enforce per-flow policies, which are useful to ensure that specific data flows, defined by IP tuples, or data packets, marked with a Differentiated Service Code Point (DSCP), are properly identified and that the transmission of uplink (UL) or downlink (DL) data flows is managed according to a designated user priority/traffic identifier (UP/TID). This limitation prevents the AP from enforcing comprehensive end-to-end (E2E) enterprise policies, creating challenges in achieving precise and adaptive management of network resources in enterprise settings.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example WLAN infrastructure in an enterprise setting, according to some embodiments of the present disclosure.

FIG. 2 depicts an example Extremely High Throughput (EHT) Capabilities element, according to some embodiments of the present disclosure.

FIG. 3 depicts an example multi-link element, according to some embodiments of the present disclosure.

FIG. 4 depicts an example sequence of interactions for SCS negotiation, where non-AP STA sends an SCS request with a desired TID and AP reviews, according to some embodiments of the present disclosure.

FIG. 5 depicts an example sequence of interactions for SCS negotiation, where AP sends an unsolicited SCS response with a designated TID, according to some embodiments of the present disclosure.

FIG. 6 depicts an example sequence of interactions for SCS negotiation, where AP sends an SCS request with a designated TID and non-AP STA responds, according to some embodiments of the present disclosure.

FIG. 7 depicts an example method for AP reviewing SCS requests from STA with a desired TCLAS-to-TID mapping and issuing counterproposals, according to some embodiments of the present disclosure.

FIG. 8 depicts an example method for STA reviewing unsolicited SCS responses from AP with a designated TCLAS-to-TID mapping, according to some embodiments of the present disclosure.

FIG. 9 is a flow diagram depicting an example method for SCS negotiation, according to some embodiments of the present disclosure.

FIG. 10 is a flow diagram depicting an example method for SCS negotiation, according to some embodiments of the present disclosure.

FIG. 11 is a flow diagram depicting an example method for SCS negotiation with unsolicited SCS responses, according to some embodiments of the present disclosure.

FIG. 12 depicts an example network device configured to perform various aspects of the present disclosure, according to some aspects of the present disclosure.

FIG. 13 depicts an example client device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by a network device from an associated station (STA), a Stream Classification Service (SCS) request comprising one or more sets of traffic class (TCLAS) information and a preferred traffic identifier (TID) value for a data flow transmitted between the STA and the network device, determining, by the network devices, a type of service of the data flow by analyzing the one or more sets of TCLAS information, confirming, by the network device, that the type of service does not align with the preferred TID value under one or more defined network policies, and in response to the confirmation, sending, by the network device to the STA, an SCS response comprising adjustments of at least one of the one or more sets of TCLAS information or the preferred TID value to a new TID value.

One embodiment presented in this disclosure provides a method, including receiving, by a station (STA) from a network device, a Stream Classification Service (SCS) request comprising one or more sets of traffic class (TCLAS) information for a data flow transmitted between the STA and the network device, and a designated traffic identifier (TID) value for the data flow, confirming, by the STA, in an SCS response sent to the network device, that the designated TID value can be adopted for handling the data flow considering one or more device settings of the STA, and in response to the confirmation, transmitting, by the STA, the data flow to the network device taking into consideration the designated TID value.

One embodiment presented in this disclosure provides a method, including receiving, by a station (STA) from a network device, an unsolicited Stream Classification Service (SCS) response comprising one or more sets of traffic class (TCLAS) information for a data flow transmitted between the STA and the network device, and a designated traffic identifier (TID) value for the data flow, and transmitting, by the STA, the data flow to the network device taking into consideration the designated TID value.

### Example Embodiments

In order to support enterprise policies that have end-to-end (E2E) service level agreements (SLAs) for business-critical flows or applications, the network needs to apply flow-specific (or application-specific) QoS policies for traffic management. To effectively manage these requirements, a negotiation process between APs and non-AP stations (STAs) is desirable to establish flow-specific policies and classify traffic flows. The process is designed to ensure that traffic classification and/or policy settings align with both E2E SLAs and the hardware and software capabilities of the AP and non-AP STAs.

Embodiments of the present disclosure introduce techniques for negotiating of flow-specific policy settings and traffic flow classification between APs and non-AP STAs. Through the negotiation, the established SCS stream may map specific data flows—defined by traffic classification (TCLAS) information (e.g., IP tuples, DSCP values) and/or QoS characteristics information (e.g., service interval, delay bound, burst size, minimum data rate)—to a TID. This mapping ensures that any UL/DL traffic flow with the specified TCLAS and QoS characteristics is transmitted at a priority level corresponding to the designated TID. Such precise management of each flow according to its significance and technical requirements facilitates alignment with predefined enterprise standards and service agreements.

The disclosed negotiation process may benefit both UL and DL traffic. For UL traffic, the current standard 802.11be does not allow non-AP STAs to report TCLAS information or QoS characteristics for UL data in SCS requests. Without this capability, the network cannot effectively apply per-flow policies to prioritize UL flows. As such, UL flows are typically treated as best effort traffic, leading to the non-fulfillment of E2E SLAs. This limitation also contributes to asymmetric QoS treatment, where DL traffic may be prioritized based on detailed TCLAS and QoS information while UL traffic is not.

The disclosed embodiments address these issues by facilitating a negotiation process between APs and STAs. The disclosed negotiation process enables STAs to report TCLAS information and QoS characteristics for specific UL traffic flows to the AP. In some embodiments, within the SCS requests, STAs may also specify the desired TID for the UL traffic flows. The AP (or a wireless local area network (LAN) controller (WLC)) then evaluates the submissions to determine their alignment with network-wide policies and/or E2E SLAs. If there is alignment, the AP (or WLC) may affirm the SCS request and manage the flow according to the desired TID. If not aligned, the AP (or WLC) may send a response with a counterproposal, suggesting a different TID or adjustments to the TCLAS information to either broaden or narrow its scope. In some embodiments, the AP may proactively send unsolicited SCS responses, which include TCLAS and QoS information for UL traffic, as well as a TID designated by the AP to manage the specified flows. Upon receiving the response, a STA may either follow the TCLAS-to-TID mappings or, if disagreeing with the mappings, may opt out of using the designated TID. Instead, the STA may revert to transmitting UL data using default procedures, such as being treated as best effort traffic.

For DL traffic, although the current standard allows for the reporting of TCLAS information to the AP, many STAs, such as laptops, phones, and Internet-of-Things (IoT) devices, often failed to provide QoS key performance indicators (KPIs) to the Wi-Fi layer for business critical flows (either because the client-side applications do not implement QoS KPIs or the operating system (OS) platform does not offer necessary APIs). Consequently, SCS requests with QoS characteristics may not be sent to the AP, causing DL traffic for business-critical applications to be sent over as best effort traffic. This may lead to the potential non-fulfillment of E2E SLAs. Additionally, even when a STA sends an SCS request with QoS characteristics for a data flow, it may not align with the network's QoS policies for that specific deployment, such as a STA requesting TID 4 for a robotics application in an industrial IoT setting, while the network policy configures it as TID 6.

The disclosed negotiation process enhances UL/DL traffic management by facilitating detailed TCLAS and QoS reporting from STAs to the AP. The negotiation process also allows for accurate classification and management of UL/DL flows according to the specific needs of business-critical applications as defined in E2E SLAs. As discussed above, the process provides a structured framework for APs to either confirm these TCLAS-to-TID mappings, or issue counterproposals that better align with the network's operational standards.

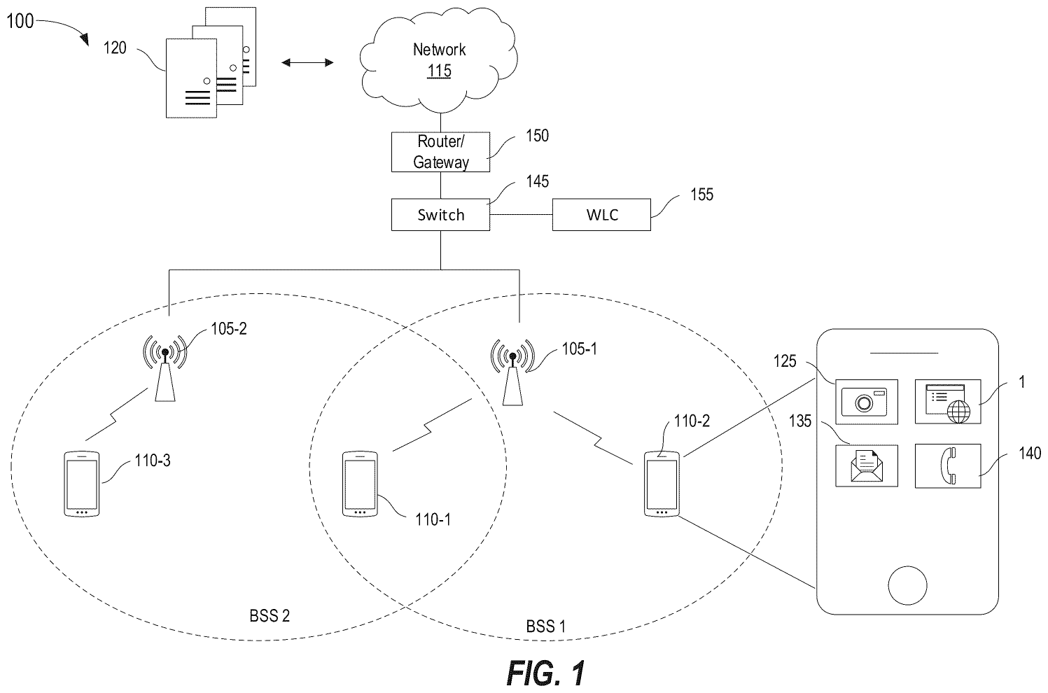

FIG. 1 depicts an example WLAN infrastructure 100 in an enterprise setting, according to some embodiments of the present disclosure.

As illustrated, the example WLAN infrastructure 100 comprises multiple BSSs, including BSS 1 and BSS 2. Each BSS consists of an AP 105 connected to multiple station devices (STAs) 110. As depicted in FIG. 1, BSS 1 includes AP 105-1, which connects to STA 110-1 and 110-2, and BSS 2 includes AP 105-2, which connects to STA 110-3.

Both APs 105 are connected to a central network switch 145, which manages UL and/or DL traffic across multiple BSSs. In the UL transmission, the switch 145 may collect data traffic from both APs 105, and route the traffic to higher network layers through the router (or gateway) 150. In the DL transmission, the switch 145 distributes incoming traffic from these higher layers to the appropriate APs 105 for delivery to the connected STA 110. The higher network layers establish connections to internal and/or external networks 115, such as the Internet. These networks 115 may connect APs 105 to remote servers 120, which function as the primary sources of various types of data that the STA 110 can request, including, but not limited to, video streaming content, web pages, voice calls, bulk data downloads, and other online services.

As depicted, the switch 145 is also communicatively coupled with a wireless local area network (LAN) controller (WLC) 155. The WLC 155 monitors all APs 105 within the BSSs and manages all wireless data exchanges between the connected STAs 110 and remote servers 120. STAs 110 in the disclosed network setup may include a wide range of computing devices, such as tablets, mobile phones, laptops, or smart home devices. In some embodiments, STAs 110 may also be referred to as client devices or user devices.

As depicted, multiple applications 125-140 may operate on a single STA 110-2, each with different requirements for UL/DL data transmission. The example WLAN infrastructure 100 enables that data flows smoothly from these remote servers 120, through the AP 105, directly to the STAs 110. This path not only supports the delivery of DL data required by applications running on the STAs, but also facilitates the uploading of UL data that may be transmitted from the STAs 110 back through the AP 105 to the wider network 115.

As depicted in FIG. 1, four applications 125-140 are installed on the STA 110-2, each requiring different handling to meet specific performance and reliability standards. Application 125 is designed for video conferencing, which typically requires high bandwidth and low latency to maintain video and audio quality. Application 140 handles phone calls, which is similar to video conferencing and requires high bandwidth and prioritization of audio transmission over others. Application 130 supports web browsing, which generally has less stringent QoS demands as compared to real-time communication services like video conferencing or audio calls. Application 135 provides reliable delivery of text messages, which typically requires minimal bandwidth.

When the example WLAN infrastructure 100 is part of an enterprise network, E2E SLAs may establish rules for managing traffic for these applications 125-140 based on their business criticality, operational requirements, and other relevant factors. For example, in an office setting, applications for day-to-day operations such as audio calls or cloud-based collaboration tools may be prioritized over less important applications like video streaming for entertainment. For applications providing similar services, such as video conferencing tools, E2E SLA may prioritize one application over another based on vendor agreements or company preferences.

To manage traffic flows for these applications in accordance with established prioritizations, the network needs to establish and implement flow-specific (or application-specific) policies. These policies may involve TCLAS-to-TID mappings, where application traffic is classified by TCLAS information (e.g., 5-tuple data) and QoS characteristics (included with QoS Characteristics element) (e.g., service interval, delay bound, burst size, minimum data rate), and is subsequently mapped to a specific TID for traffic management. For example, a flow-specific policy may be established to map traffic flows for application 125, identified by its specific 5-tuple data, to TID 7. This policy ensures that traffic for application 125 receives the necessary priority and network resources.

When setting up these flow-specific policies, a negotiation process is needed to ensure that these policies align with the enterprise's strategic objectives and E2E SLAs. The negotiation process may include dynamic interactions between APs and non-AP STAs to adjust TCLAS-to-TID mappings. In some embodiments, the negotiation process may include the STA 110-2 sending an SCS request to its associated AP 105-1. The SCS request may include TCLAS information and/or QoS characteristics, along with a desired TID to manage specific UL/DL traffic flows. For example, for certain UL data flows that are being sent or will be sent by the STA 110-2 to the AP 105-1, the STA 110-2 may send an SCS request specifying the TCLAS information (e.g., 5-tuple data) and QoS characteristics (e.g., service interval, delay bound) for these data flows. Within the SCS request, the STA 110-2 may further indicate the preferred (or desired) TID for managing these data flows according to specific QoS requirements. Upon receiving the SCS request, the AP 105-1 may review the provided data against current network policies and/or service agreements (e.g., E2E SLAs). If the request aligns with network policies, the AP 105-1 may approve the TID and set the requested traffic prioritization. If not aligned, the AP 105-1 may issue a counterproposal, suggesting an alternative TID that better accommodates the traffic type, or it may request modifications to the TCLAS settings to better manage network resources. In some embodiments, the modifications may include either broadening or narrowing the scope of the TCLAS information. For example, narrowing the scope may involve specifying more detailed parameters within the TCLAS to target specific types of traffic (or traffic for a specific application) more accurately, such as refining the source or destination IP addresses, specifying certain protocol types, or narrowing the port ranges. In contrast, broadening the scope may include relaxing some parameters to accommodate a wider range of traffic under the same classification, such as including broader IP address ranges, expanding the range of port numbers, or accommodating multiple protocol types.

In some embodiments, the negotiation process may be initiated by the AP 105-2, which sends an unsolicited SCS response to the STA 110-2. The response may include predetermined TCLAS and QoS settings, along with a TID designated by the AP 105-2 for specific UL/DL flows. The STA 110-2, upon receiving the unsolicited SCS response, may decide whether to adapt its traffic flows according to the AP's specifications or to reject the AP's settings and continue to use its existing configurations (e.g., SCS stream reserved for best effort traffic).

In some embodiments, the AP 105-2 may use an SCS request to communicate the TCLAS and QoS settings, as well as the designated TID. Upon receiving the request, the STA 110-2 may review and decide whether to accept or reject the AP's proposed settings. If accepted, the STA 110-2 may send a response comprising a status of “Success” and adjust its traffic flows to conform to the new guidelines (e.g., transmitting the flows using the established SCS stream). If rejected, the STA 110-2 may continue using its existing configurations (e.g., SCS stream reserved for best effort traffic) to send the data flows, or it may send another SCS request indicating its preferred TID for further negotiation. The AP 105-2 may then review this subsequent request, verify the alignment with network policies, and, if necessary, send a counterproposal to better suit the traffic types.

In some embodiments, the negotiation may occur between the STA 110-2 and the WLC 155 instead of directly with the AP 105-1. This adjustment may be implemented because the WLC 155 oversees network-wide policies, making it more effective at enforcing the QoS requirements set by E2E SLAs. Additionally, the negotiation process may apply to either UL traffic, DL traffic, or both. Through the negotiation, the network may establish per-flow (or per-application) policies that better align traffic management with the network's strategic objectives and service level agreements (SLAs). This is particularly useful in enterprise environments where the precise management of diverse traffic types is required. The central coordination through the WLC 155 ensures that all traffic management policies are established and enforced consistently across the network.

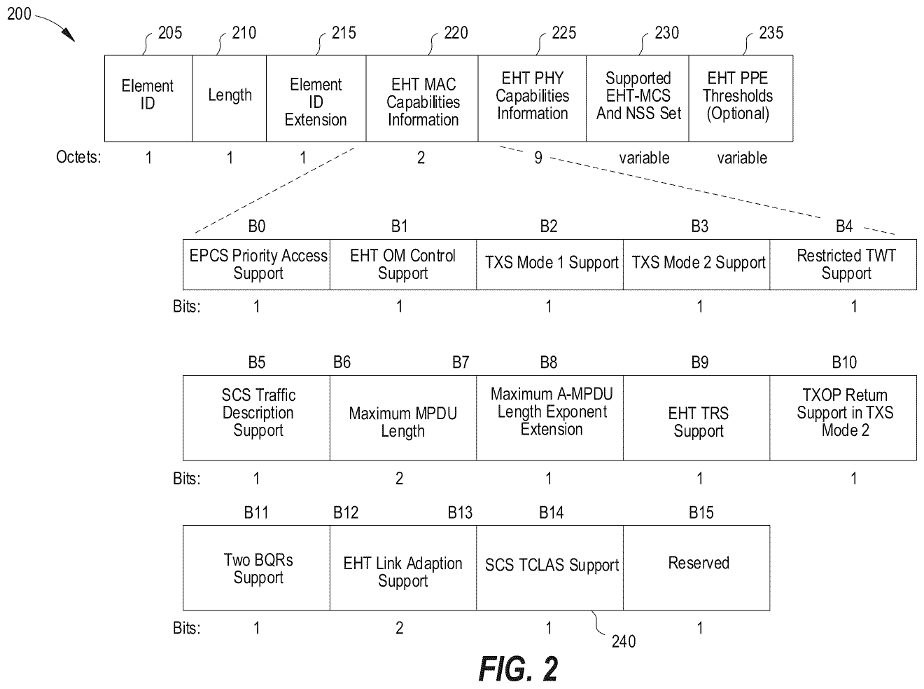

FIG. 2 depicts an example Extremely High Throughput (EHT) Capabilities element 200, according to some embodiments of the present disclosure. The example EHT Capabilities element 200 may be used by APs (e.g., 105 of FIG. 1) or non-AP STAs (e.g., 110 of FIG. 1) to declare their capabilities within an EHT environment. The example element 200 may be transmitted as part of a management frame, such as an association request/response frame, to communicate the specific EHT functionalities supported by the device.

As illustrated, the EHT capabilities element 200 includes seven fields that are utilized to advertise the EHT capabilities of a device. These fields include Element ID 205, Length 210, Element ID Extension 215, EHT MAC Capabilities Information 220, EHT PHY Capabilities Information 225, Supported EHT-MCS And NSS Set 230, and EHT PPE Thresholds (optional) 235. The EHT MAC Capabilities Information 220 field may detail capabilities specific to the MAC layer. As illustrated, the EHT MAC Capabilities Information 220 field further includes 14 subfields. In the present disclosure, a new subfield 240 labeled “SCS TCLAS Support” is added, potentially before the Reserved subfield. This new subfield 240 is configured to indicate whether the device has the capability to make TCLAS recommendations and handle counterproposals during the QoS negotiation process. For example, a STA may use this subfield 240 to declare to the AP its capability of reporting the TCLAS and QoS settings for specific UL/DL flows and the preferred TID for traffic management. Additionally, an AP may use the subfield 240 in its association response to indicate its capability of validating the received TID against network policies and providing counterproposals for adjustments to the TCLAS information or an alternative TID.

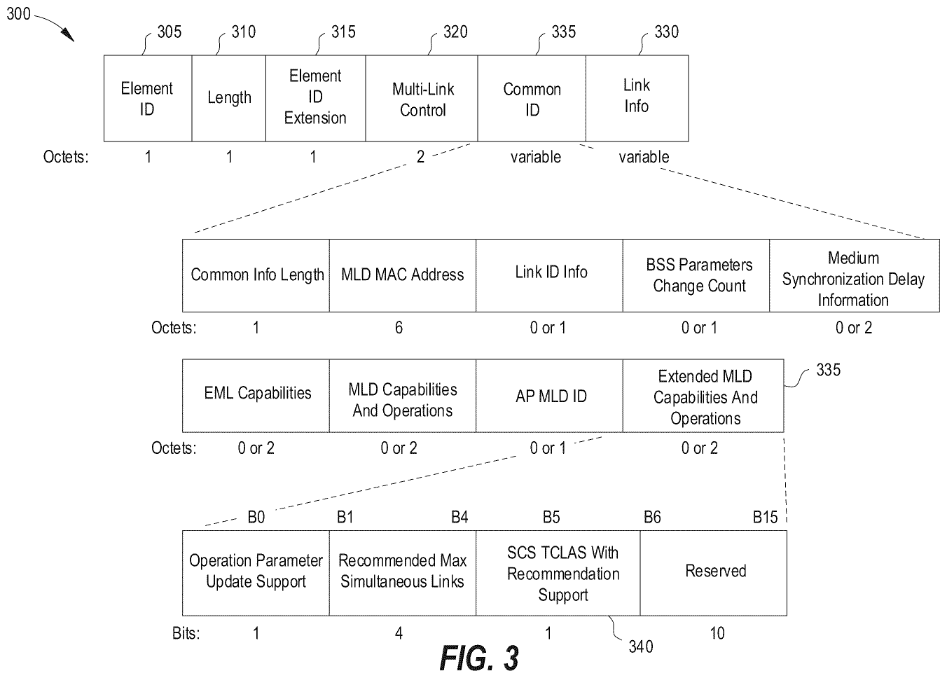

FIG. 3 depicts an example multi-link element 300, according to some embodiments of the present disclosure. The multi-link element 300 may be used in frames associated with the configuration and management of multi-link devices (MLDs), such as link configuration request/response frames, link management frames, or association request/response frames.

As illustrated, the multi-link element 300 consists of six fields, including Element ID 305, Length 310, Element ID Extension 315, Multi-Link Control 320, Common Information 325, and Link Information 330. The Common Information field 325 provides general settings and parameters shared across links within the MLD, and consists of nine subfields. Among the nine subfields, the extended MLD Capabilities and Operations subfield 335 provides extended capabilities and operational settings of the MLD.

In the present disclosure, a new subfield 340 labeled “SCS TCLAS With Recommendation Support” is added before the Reserved subfield. The new subfield is designed specifically to indicate the MLD's capability for making TCLAS recommendations and handling counterproposals during the negotiation process. In some embodiments, for a MLD STA (e.g., 110 of FIG. 1), the subfield 340 may be included in a link configuration request sent to its associated MLD AP (e.g., 105 of FIG. 1), informing the MLD AP of the MLD STA's ability to report TCLAS and/or QoS information for specific UL/DL flows, as well as a preferred TID for traffic management. In some embodiments, the MLD AP (e.g., 105 of FIG. 1) may use this subfield 340 in a link configuration response to demonstrate its ability to assess the proposed TID against established network policies and to offer modifications to the TCLAS details or suggest an alternative TID.

The example elements 200 and 300 depicted in FIGS. 2 and 3, which demonstrate how devices may declare their capabilities to support TCLAS recommendations, are provided for conceptual clarity. In some embodiments, other types of elements may be used depending on the network requirements and configurations.

In some embodiments, the declaration of support for TCLAS recommendation and related QoS settings may be a precondition for an STA to access SCS streams (also referred to as preferred links) set up by the AP following the enforcement of per-flow policies. For example, prior to engaging in negotiation, the AP may indicate that it requires the client device to support the TCLAS features (e.g., reporting TCLAS information and/or QoS characteristics). Without this functionality, the STA cannot effectively participate in the negotiation process. Consequently, it cannot access the SCS streams (e.g., preferred links reserved for high priority traffic) that the AP has reserved for transmitting specified UL/DL traffic flows.

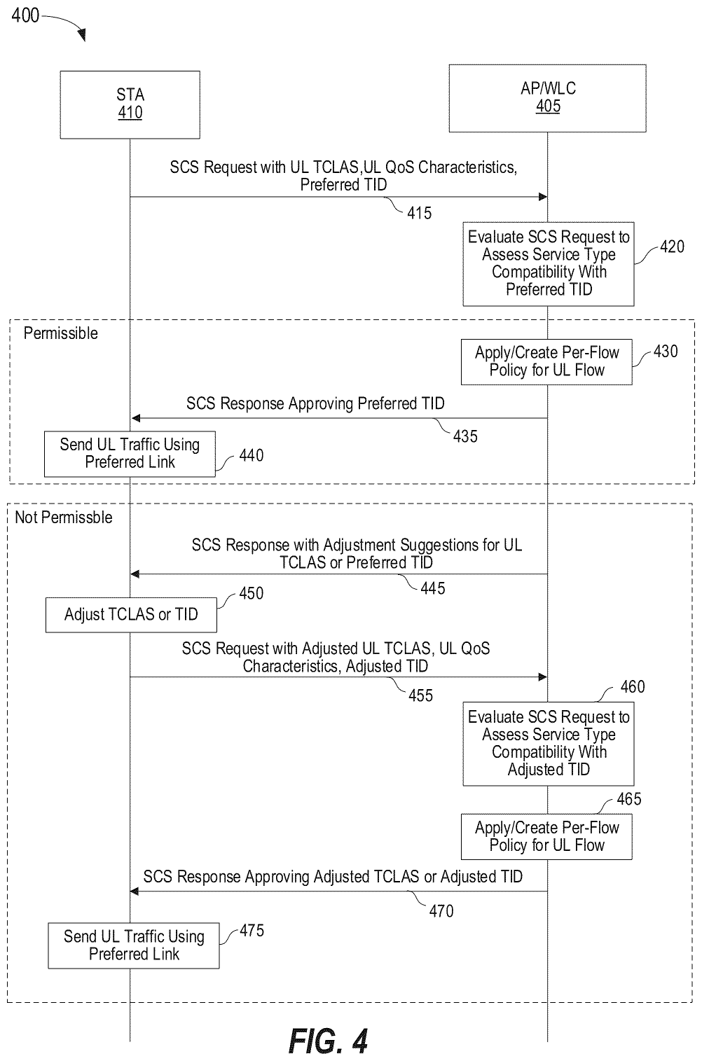

FIG. 4 depicts an example sequence of interactions 400 for SCS negotiation, where non-AP STA 410 sends an SCS request with a desired TID and AP 405 reviews, according to some embodiments of the present disclosure. In some embodiments, the STA 410 may correspond to the STA 110 as depicted in FIG. 1. In some embodiments, the entity 405 receiving the SCS request may correspond to the AP 105 or the WLC 155 as depicted in FIG. 1, or any other specialized network devices designed to handle policy negotiation and enforcement.

As illustrated, the STA 410 sends an SCS request to the AP/WLC 405 (step 415). The SCS request may include detailed information indicating the type of service or application classification for upcoming (or ongoing) UL traffic. In some embodiments, the SCS request may include the TCLAS element and/or QoS Characteristics element. The TCLAS element may provide information specific to the UL traffic, such as source and destination IP addresses, source and destination port numbers, protocol type, differentiated services code point (DSCP) value, and other identifiers. The QoS Characteristics element may include parameters such as service interval, delay bound, burst size, minimum data rate, and the like. Based on the TCLAS and/or QoS Characteristics elements, the AP/WLC 405 may determine the type of service the UL traffic is intended for (e.g., audio, video) or even identify the specific application it is serving (e.g., Webex®). The detailed classification may help the AP/WLC 405 to make informed decisions about prioritizing and managing the UL traffic.

In some embodiments, the SCS request may further indicate a TID that the STA 410 prefers to hand the UL traffic flows with the specified TCLAS and/or QoS settings. For example, for UL traffic flows serving video conferencing application (e.g., application 125 of FIG. 1), the TCLAS element within the SCS request may include the source IP address of the STA 410, the destination IP address of a conferencing server (e.g., 120 of FIG. 1), the source and destination port numbers typically used for video conferencing applications, and the protocol types (e.g., User Datagram Protocol (UDP) for real-time streaming). The QoS characteristics element within the SCS request may include a low delay bound to reduce latency, a high minimum data rate to ensure video quality, and a burst size accommodating sudden increases in data rate that typically occur during video transmission. Additionally, the SCS request may further specify a desired TID of 7, indicating the STA's 410 preference to prioritize video conferencing UL traffic above other less important data flows in the network.

In some embodiments, the SCS requests may further include identifiers such as a Fully Qualified Domain Name (FQDN)/URL (e.g., “conference.example.com”) or an application ID (which may be specific to the operating system) that facilitate the precise identification of traffic flows for an application. These identifiers allow the AP/WLC 405 to apply more targeted traffic management policies based on the exact nature of the application traffic.

Upon receiving the SCS request, the AP/WLC 405 analyzes the provided TCLAS and/or QoS characteristics to determine the type of service the UL traffic is intended for (e.g., audio, video) or even identify the specific application the UL traffic is serving (e.g., applications 125-140 of FIG. 1) (step 420). This analysis may involve parsing the IP tuple data (e.g., source and destination IPs, port numbers, protocol types), DSCP values included within the packet headers, and QoS parameters provided (e.g., burst size, delay bound, minimum data rate, service interval), and comparing the data with known patterns or predefined profiles for various services and applications to accurately classify and prioritize the UL traffic.

However, since IP tuple data for an application can be dynamic and subject to changes (due to factors like network reconfigurations, IP address changes, and port reallocations), relying solely on TCLAS and/or QoS characteristics data may sometimes lead to inaccuracies in traffic classification. As discussed above, to enhance reliability and precision in identifying in traffic classification, in some embodiments, the SCS request may also include more static identifiers, such as FQDN/URL or application ID. These identifiers provide more stable and definitive references that help the network to consistently classify data flows, even as network conditions or endpoint configuration change. When such static identifiers are provided in the SCS request (step 415), the AP/WLC 405 may utilize these identifiers to directly map UL traffic to a specific application, bypassing the variability of IP-based classification. For example, a FQDN/URL like “conference.example.com” may directly associate the UL traffic to a high-priority video conferencing application, regardless of changes in IP configurations.

After determining the type of service and/or identifying the specific application, the AP/WLC 405 then proceeds to assess whether the TID requested by the STA 410, in view of the classified service type or application, is permissible (or justified) under current network policies and/or service agreements. The validation process ensures that the allocation of network resources aligns with the predefined network-wide policies. If the requested TID is permissible (or justified), the AP/WLC 405 proceeds to create and/or enforce a per-flow (or per-application) policy specifically for the SCS request (step 430). Such operations may include the AP/WLC 405 allocating the necessary network resources to establish an SCS stream (also referred to in some embodiments as a preferred link) for transmitting the specified UL traffic flows (with the defined TCLAS and/or QoS characteristics) at the requested level of service quality.

In parallel or subsequent to the setup of the SCS stream, the AP/WLC 405 sends an SCS response back to the STA 410 (step 435). The response approves the preferred TID, and may include a status of “Success,” indicating that the requested configurations have been successfully implemented and that the STA 410 may begin transmitting its UL traffic flows through the established SCS stream.

Upon receiving the SCS response, the STA 410 starts sending the UL traffic with the defined TCLAS and/or QoS characteristics using the established SCS stream (step 440). As such, the UL traffic is managed under the terms agreed upon in the SCS negotiations, allowing it to receive the necessary priority and resources as dictated by the approved TID.

If the requested TID is not permissible (or justified) under current network policies and/or service agreements, the AP/WLC 405 sends a response rejecting the preferred TID (step 445). In some embodiments, the SCS response may further include detailed feedback on any required adjustments or discrepancies related to the initial request. For example, the response may 445 narrow or broaden the scope of TCLAS information by adjusting various parameters, such as the range of IP addresses, port numbers, or protocol types used to define the traffic. In some embodiments, narrowing the scope may involve specifying more precise IP ranges or specific ports related to a specific application, making traffic for this application handled according to a specific TID (e.g., TID 7). In some embodiments, broadening the scope may include expanding the range of IP addresses or including additional ports that relate to multiple applications within the same type of service. Such adjustments may accommodate a wider variety of similar traffic under the same classification, allowing traffic for these multiple applications to all be managed according to a specific TID (e.g., TID 7).

In embodiments where application ID and/or FQDN/URL are included in the SCS request (step 415), narrowing the scope may include targeting specific web services or applications for enhanced traffic management. Alternatively, broadening the scope may include expanding the range of URLs associated with a category of services (e.g., video streaming) to ensure these applications receive uniform treatment.

In some embodiments, the AP/WLC 405 may suggest an alternative TID in the SCS response (step 455). The alternative TID may align better with the determined traffic type or application classification. For example, if the TID preferred (or requested) by STA 410 was intended for high-priority video streaming (e.g., TID 7), but the TCLAS and QoS information provided in the SCS request suggests that the traffic more likely relates to video downloads rather than real-time streaming, the AP/WLC 405 may propose a TID (e.g., TID 5) that still prioritizes the traffic appropriately but under a slightly modified set of parameters.

Following the receipt of the SCS response from the AP/WLC 405, the STA 410 reviews the feedback and makes necessary adjustments to the TCLAS information or changes the TID as suggested (step 450). The STA 410 then sends another SCS request with the adjusted TCLAS information, the adjusted TID, or both, depending on the feedback received (step 455).

The AP/WLC 405 re-evaluates the new SCS request (step 460), performing an analysis similar to the one implemented at step 420. The reassessment may include checking the newly provided TCLAS and QoS parameters, as well as the adjusted TID against the network policies. If permissible, the AP/WLC 405 then proceeds to create and/or apply a per-flow (or per-application) policy specifically for the SCS request (step 465). This may include allocating the necessary network resources to setup the SCS stream (or preferred link) for transmitting the specified UL flows. The AP/WLC 405 then sends another SCS response (step 470), approving the second SCS request (which includes either adjusted TCLAS information, adjusted TID, or both). Upon receiving the SCS response, the STA 410 starts transmitting its UL traffic using the designated SCS stream (or preferred link) (step 475).

In some embodiments, particularly in dynamic network environments, the SCS responses at steps 435 and 470 may be sent prior to the actual creation of the SCS stream, providing the STA 410 with an immediate response based on real-time evaluations of the requested TCLAS-to-TID mapping.

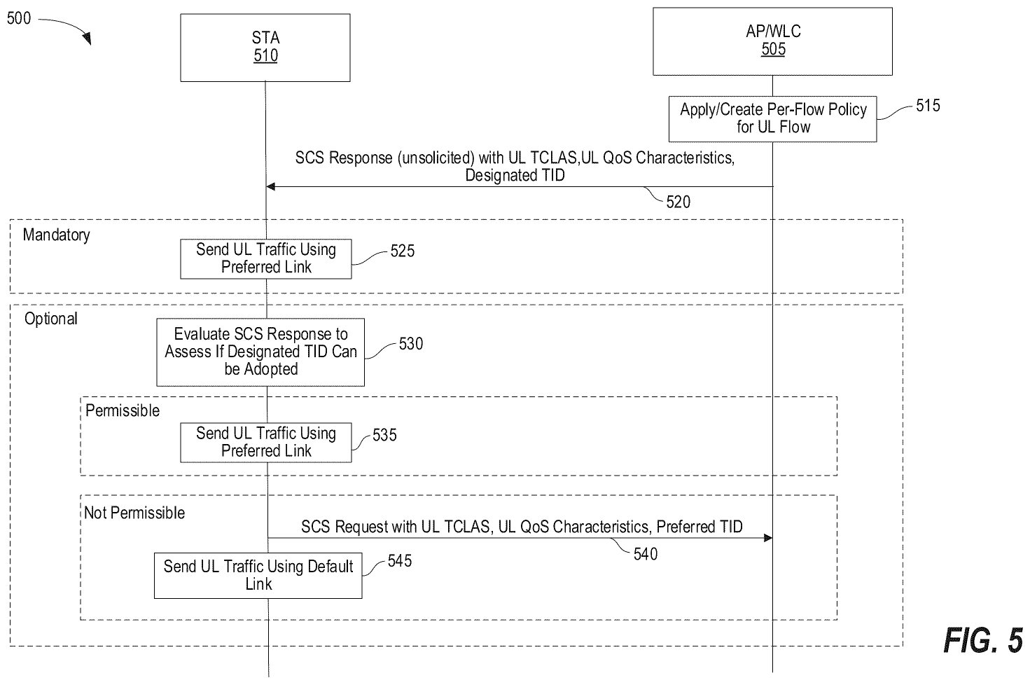

FIG. 5 depicts an example sequence of interactions for SCS negotiation, where AP 505 sends an unsolicited SCS response with a designated TID, according to some embodiments of the present disclosure. In some embodiments, the STA 510 may correspond to the STA 110 as depicted in FIG. 1. In some embodiments, the entity 505 sending the unsolicited SCS response may correspond to the AP 105 or the WLC 155 as depicted in FIG. 1, or any other specialized network devices designed to handle policy negotiation and enforcement.

As illustrated, the AP/WLC 505, guided by network-wide policies and E2E SLAs, creates and/or applies a per-flow policy to establish an SCS stream for one or more UL traffic flows (step 515). These UL traffic flows share common TCLAS and/or QoS parameters and may correspond to one or more applications.

After establishing the SCS stream, the AP/WLC 505 sends an unsolicited SCS response to the STA 510 (step 520). The SCS response may include detailed information about the TCLAS information (e.g., 5-tuple data, application ID, FQDN/URL) QoS characteristics (e.g., service interval, delay bound, burst size, minimum data rate) for the UL traffic flows, along with the currently designated TID for the SCS stream (e.g., TID 7). In some embodiments, the SCS response may further include a field indicating whether following the designated TCLAS-to-TID mapping is mandatory or optional.

If the SCS response indicates that following the mapping is mandatory, the STA 510 proceeds to transmit UL traffic flows that fall within the specified TCLAS range using the established SCS stream (or preferred link) (step 535). If the SCS response indicates that following the mapping is optional, the STA 510 evaluates the proposed settings to determine whether the designated TID is compatible with (or adaptable to) its own device configurations. In some embodiments, the STA may check for any operational constraints that may affect its ability to adopt the designated TCLAS-to-TID mapping. The STA may assess its hardware capabilities, software settings, security policies, and/or any regulatory restrictions in place.

If the STA 510 finds that the designated mapping is acceptable, the STA 510 proceeds to send UL traffic within the specified TCLAS range using the established SCS stream (or preferred link) (step 535). In this configuration, the UL traffic benefits from the optimized resource allocation and QoS handling as stipulated in the SCS stream setup.

If the STA 510 finds that the mapping is not acceptable, in one embodiment, the STA 510 may terminate the SCS session initiated by the unsolicited SCS response. The STA 510 may then send a new SCS request to the AP with a preferred TID (step 540). The AP/WLC 505, upon receiving the new request, may perform a further analysis as discussed in FIG. 4. In another embodiment, the STA 510 may send its UL traffic using a default SCS stream (also referred to in some embodiments as a default link), such as the stream reserved for best effort traffic. The default SCS stream does not guarantee specific QoS treatments but offers greater flexibility.

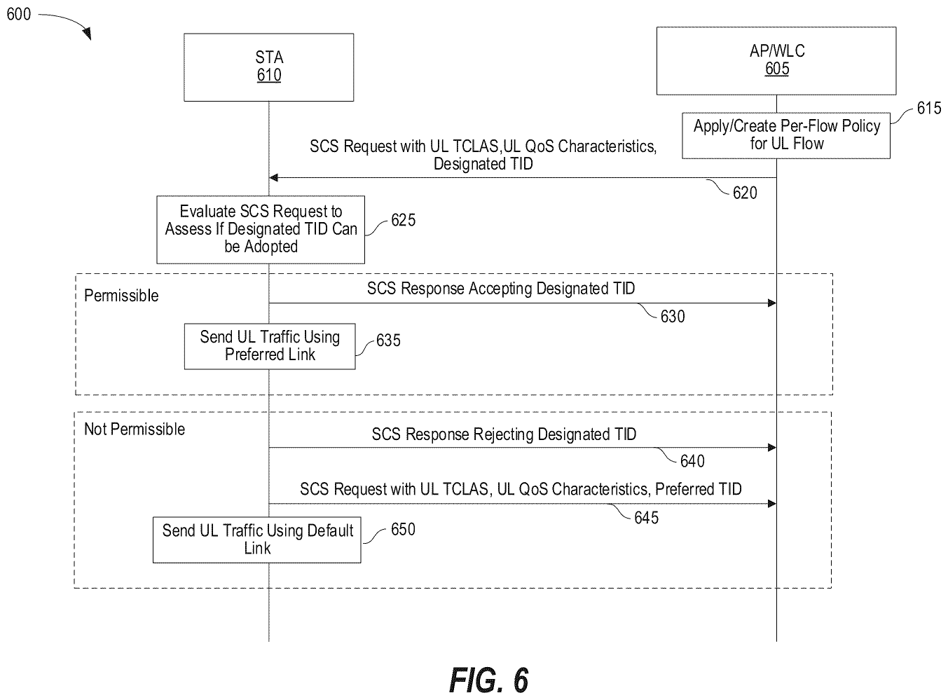

FIG. 6 depicts an example sequence of interactions 600 for SCS negotiation, where AP 605 sends an SCS request with a designated TID and non-AP STA 610 responds, according to some embodiments of the present disclosure. In some embodiments, the STA 610 may correspond to the STA 110 as depicted in FIG. 1. In some embodiments, the entity 605 sending the SCS request may correspond to the AP 105 or the WLC 155 as depicted in FIG. 1, or any other specialized network devices designed to handle policy negotiation and enforcement.

As illustrated, the AP/WLC 605 creates a per-flow policy guided by network-wide policies and/or E2E SLAs. The per-flow policy is then applied to set up an SCS stream for handling specific UL traffic flows (step 615). These UL traffic flows share common TCLAS and/or QoS parameters and may correspond to one or more applications.

The AP/WLC 605 sends an SCS request to the STA 610 (step 620), which includes TCLAS and QoS characteristics for the UL flows, as well as a designated TID. Upon receiving the SCS request, the STA 610 evaluates whether the designated TID mapping can be adopted or followed (step 625). The evaluation may include assessing the STA's local configurations (e.g., hardware and/or software capabilities) or any operational constraints that may impact its implementation (e.g., security policies, regulatory restrictions). If the designated TID mapping is acceptable, the STA 610 sends an SCS response to the AP/WLC 605 (step 630), approving the SCS request. In some embodiments, the response may include an indicator of “Success.” The STA then begins using the established SCS stream to transmit the UL traffic that falls within the specified TCLAS range (step 635). If the designated TID mapping is not acceptable, the STA 610 sends a response to the AP/WLC 605 (step 640), rejecting the SCS request. In some embodiments, the response may include an indicator of “Failure.” Alternatively, in another embodiment, the STA 610 may send a new SCS request to the AP with a new TID it prefers for handling the UL traffic. The new SCS request may prompt the AP/WLC 605 to perform a similar analysis as discussed in FIG. 4. In another embodiment, the STA may opt to use a default SCS stream (e.g., a stream reserved to best effort traffic) to transmit the UL traffic (step 650).

In some embodiments, the SCS request (step 620) may include a field indicating whether adopting the designated TID and/or the one or more sets of QoS characteristics information for the UL flows is mandatory or optional to follow by the STA.

The example sequences of interactions for policy negotiation, as depicted in FIGS. 4, 5, and 6, that are applied for UL traffic are provided for conceptual clarity. In some embodiments, the sequences of interactions for policy negotiation may also be equally applied to DL traffic flows. The steps involved in establishing and negotiating traffic management policies, such as sending SCS requests with TCLAS and/or QoS characteristics, the AP's evaluation of requested TIDs, and creating/applying per-flow policies, are the same for both directions of traffic.

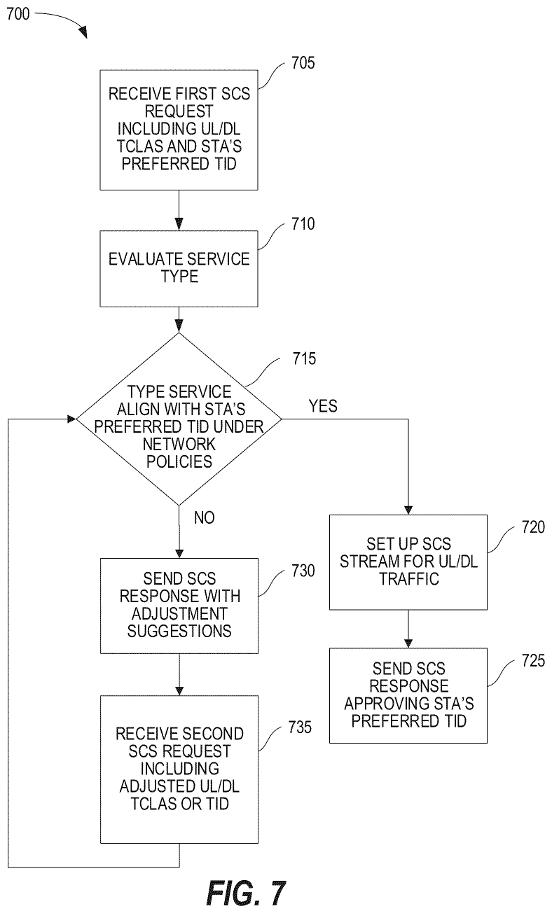

FIG. 7 depicts an example method 700 for AP reviewing SCS requests from STA with a desired TCLAS-to-TID mapping and issuing counterproposals, according to some embodiments of the present disclosure. In some embodiments, the method 700 may be performed by one or more network devices that possess the necessary capabilities for policy negotiation, such as WLCs 155 and/or APs 105 as depicted in FIG. 1, or AP/WLC 405 as depicted in FIG. 4.

At block 705, an AP (e.g., 405 of FIG. 4) receives a first SCS request from an associated STA (e.g., 410 of FIG. 4). The first SCS request may include TCLAS information and/or QoS characteristics for one or more UL/DL traffic flows, as well as a TID preferred by the STA for handling the specified traffic flows.

At block 710, the AP evaluates the service type or application classification of the UL/DL traffic flows based on the provided TCLAS and/or QoS parameters.

At block 715, the AP determines whether the service type or application classification aligns with the preferred TID under the existing network-wide policies and/or E2E SLAs. This may include assessing whether the preferred TID is suitable for the UL/DL traffic's priority and service needs as defined by the network's operational guidelines and/or service agreements.

If there is alignment, the method 700 proceeds to block 720, where the AP sets up an SCS stream for the specified UL/DL traffic. This may involve configuring network resources to ensure the UL/DL traffic is handled according to the agreed priority level (e.g., the preferred TID). At block 725, the AP sends an SCS response back to the STA, approving the preferred TID. In another embodiment, the SCS response may be sent prior to the successful setup of the SCS stream.

If the preferred TID does not align with the network policies, the method 700 proceeds to block 730, where the AP sends an SCS response to the STA suggesting adjustments. Within the SCS response, the AP may propose an alternative TID or request modifications to the TCLAS information to better fit the network's policies and/or service agreements. At block 735, the AP receives a second SCS request from the STA, which includes the adjusted TCLAS and/or TID based on the suggestions provided. Following the receipt of the second request, the method 700 returns to block 715, where the AP rechecks the alignment of the service type or application classification (indicated by the TCLAS information) with the adjusted TID. If the revised parameters are now aligned under the network policies, the method 700 proceeds to block 720 to set up the SCS stream based on these adjustments. If not, further adjustments may be required, and the process may cycle through negotiation steps again to find a viable configuration.

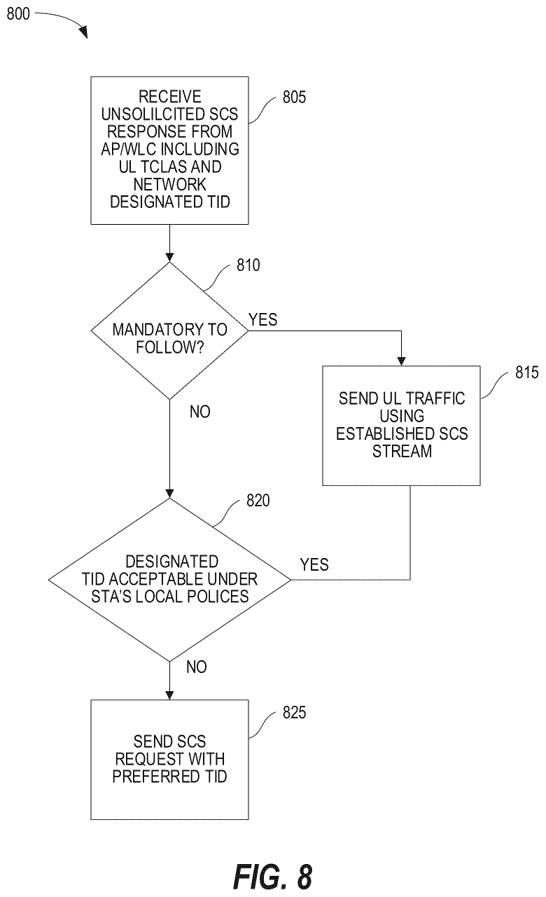

FIG. 8 depicts an example method 800 for STA reviewing unsolicited SCS responses from AP with a designated TCLAS-to-TID mapping, according to some embodiments of the present disclosure. In some embodiments, the method 800 may be performed by one or more network devices that possess the necessary capabilities for policy negotiation, such as STAs 110 as depicted in FIG. 1 and STA 510 as depicted in FIG. 5.

At block 805, an STA (e.g., 510 of FIG. 5) receives an unsolicited SCS response from its associated AP (e.g., 505 of FIG. 5). The SCS response may include TCLAS and/or QoS information for one or more UL/DL traffic flows, as well as a TID designated by the AP for handling these specified flows.

At block 810, the STA evaluates the SCS response to determine whether the TCLAS-to-TID mapping is mandatory to follow. If the mapping is mandatory, the method 800 proceeds to block 815, where the STA sends the UL/DL traffic flows (e.g., falling within the TCLAS range) using the established SCS stream. If the mapping is optional to follow, the method 800 proceeds to block 820, where the STA evaluates whether the designated TID is acceptable or can be adopted for handling the specified UL/DL traffic. The STA may consider its device settings, such as hardware capabilities or software configurations, to determine whether these factors may constrain its ability to adopt the designated mapping. If the designated TID is considered acceptable, the method 800 moves to block 815, where the STA sends UL/DL traffic using the established SCS stream. If the designated TID cannot be adopted, potentially due to insufficient hardware capabilities or incompatible software settings, the method 800 proceeds to block 825, where the STA sends a new SCS request with a preferred TID. The new SCS request may prompt the AP to perform an analysis similar to that depicted in FIG. 7 (e.g., reassessing the request in light of network-wide policies).

Alternatively, in another embodiment, upon determining that the designated TID cannot be adopted, the STA may proceed to transmit the UL/DL traffic using a default SCS stream (e.g., a stream reserved for best effort traffic).

In some embodiments, the message received by the STA (e.g., 610 of FIG. 6) at block 805 may be an SCS request sent by the AP (e.g., 605 of FIG. 6), rather than an SCS response. The request may include the TCLAS and QoS information, along with the designated TID. Upon receiving the SCS request, the STA performs a detailed evaluation to determine whether the designated TID can be adopted by the STA on its current operational settings and constraints. Based on the evaluation, if the designated TID can be adopted, the STA sends an SCS response back to the AP, confirming the designated TID. If the STA determines that the designated TID cannot be adopted, the STA sends an SCS response to the AP, indicating a status of “Failure” to reject the designated TID. Following that, in some embodiments, the STA may propose an alternative TID in a new SCS request. The alternative TID may better suit the STA's capabilities. The AP, upon receiving the new SCS request, may perform an analysis similar to that depicted in FIG. 7.

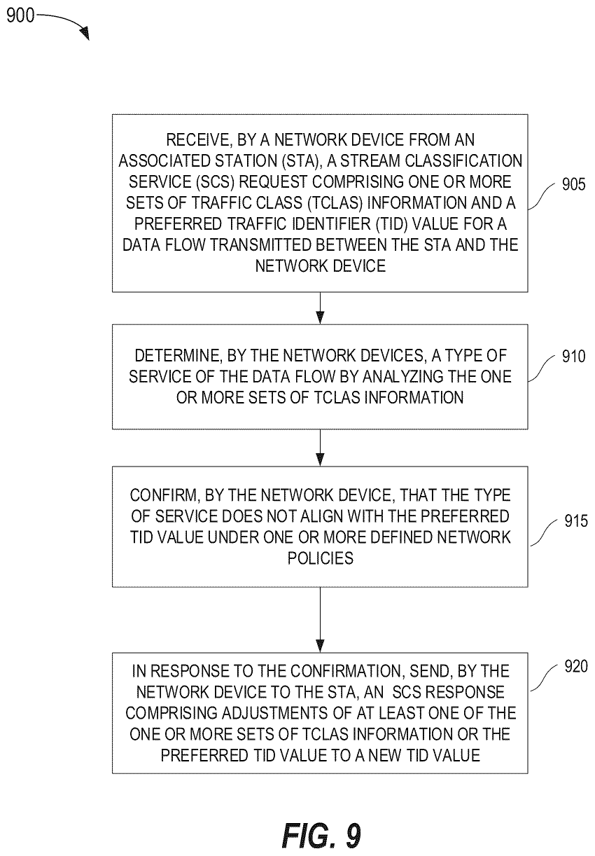

FIG. 9 is a flow diagram depicting an example method for SCS negotiation, according to some embodiments of the present disclosure.

At block 905, a network device (e.g., AP/WLC 405 of FIG. 4) receives a Stream Classification Service (SCS) request from an associated station (STA) (e.g., 410 of FIG. 4), the SCS request comprising one or more sets of traffic class (TCLAS) information and a preferred traffic identifier (TID) value for a data flow transmitted between the STA and the network device (as depicted by block 705 of FIG. 7).

At block 910, the network devices determines a type of service of the data flow by analyzing the one or more sets of TCLAS information (as depicted by block 710 of FIG. 7).

At block 915, the network device confirms that the type of service does not align with the preferred TID value under one or more defined network policies of the network device (as depicted by block 715 of FIG. 7).

At block 920, in response to the confirmation, the network device sends an SCS response to the STA, the SCS response comprising adjustments of at least one of the one or more sets of TCLAS information or the preferred TID value to a new TID value (as depicted by block 720 of FIG. 7).

In some embodiments, the data flow may comprise an uplink data flow transmitted from the STA to the network device. In some embodiments, the data flow may comprise a downlink data flow transmitted from the network device to the STA.

In some embodiments, the network device may receive a second SCS request from the STA incorporating the adjustments (as depicted by block 735 of FIG. 7), confirm that the adjusted one or more sets of TCLAS information align with the preferred TID value under the one or more defined network policies (as depicted by block 715 of FIG. 7), allocate network resources to the data flow per the preferred TID value (as depicted by block 720 of FIG. 7), and send a second SCS response confirming the preferred TID value (as depicted by block 725 of FIG. 7).

In some embodiments, the network device may receive a second SCS request from the STA incorporating the adjustments (as depicted by block 735 of FIG. 7), confirm that the one or more sets of TCLAS information aligns with the new TID value under the one or more defined network policies (as depicted by block 715 of FIG. 7), allocate network resources to the data flow per the new TID value (as depicted by block 720 of FIG. 7), and send a second SCS response confirming the new TID value (as depicted by block 725 of FIG. 7).

In some embodiments, the SCS request may further comprise one or more sets of quality of service (QoS) characteristics information. In some embodiments, to determine the type of service of the data flow, the network device may analyze both the one or more sets of TCLAS information and the one or more sets of quality of service (QoS) characteristics information.

In some embodiments, the network device may send adjustments of the one or more sets of QoS characteristics information for the data flow in the SCS response.

In some embodiments, the network device may send a failure status code in the SCS response if the one or more sets of TCLAS information are not included for the data flow.

In some embodiments, each set of the one or more sets of TCLAS information may comprise at least one of 5-tuple data, an application ID, or a web address or a fully qualified domain name (FQDN).

In some embodiments, each set of the one or more sets of QoS characteristics information may comprise at least one of a service interval, delay bound, burst size, or minimum data rate.

In some embodiments, the adjustments of the one or more sets of TCLAS information may comprise at least one of narrowing a scope of the one or more sets of TCLAS information, comprising limiting, by the network device, a range of IP addresses, port numbers, or port types to the preferred TID, or broadening the scope of the one or more sets of TCLAS information, comprising, expanding, by the network device, the range of IP addresses, port numbers, or protocol types to the preferred TID.

In some embodiments, the network device may comprise at least one of an access point (AP), a wireless local area network controller (WLC), a network security appliance, or a gateway.

In some embodiments, the STA or the network device may indicate a support for at least one of TCLAS inclusion for uplink data flows, TCLAS negotiation, or preferred TID negotiation via a capability field in a management frame.

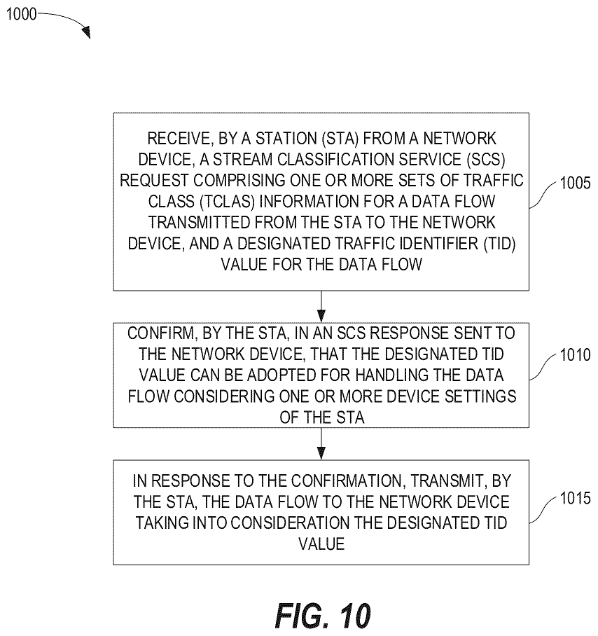

FIG. 10 is a flow diagram depicting an example method 1000 for SCS negotiation, according to some embodiments of the present disclosure.

At block 1005, a STA (e.g., 610 of FIG. 6) receives a Stream Classification Service (SCS) request from a network device (e.g., 605 of FIG. 6) comprising one or more sets of TCLAS information for a data flow transmitted between the STA and the network device, and a designated traffic identifier (TID) value for the data flow (as depicted by step 620 of FIG. 6).

At block 1010, the STA confirms, in an SCS response sent to the network device, that the designated TID value can be adopted for handling the data flow considering one or more device settings of the STA (as depicted by step 630 of FIG. 6).

At block 1010, the STA transmits the data flow to the network device taking into consideration the designated TID value (as depicted by step 635 of FIG. 6).

In some embodiments, the SCS request may further comprise one or more sets of QoS characteristics information for the data flow, and an indication that the one or more sets of QoS characteristics information can be considered for transmitting the data flow.

In some embodiments, the SCS request may further comprise a field indicating whether adopting at least one of the designated TID or the one or more sets of QoS characteristics information for the data flow is mandatory or optional to follow by the STA.

In some embodiments, the STA may receive a second SCS request from the network device, the second SCS request comprising one or more second sets of TCLAS information for a second data flow transmitted between the STA and the network device, a second designated TID value for the second data flow (as depicted by step 630 of FIG. 6). The STA may determine that the second designated TID value cannot be adopted for handling the second data flow considering the one or more device settings of the STA (as depicted by step 625 of FIG. 6). The STA may send a second SCS response rejecting the second SCS request (as depicted by step 640 of FIG. 6).

In some embodiments, the STA may receive a second SCS request from a network device, comprising one or more sets of traffic class (TCLAS) information for a second data flow transmitted between the network device and the STA, and at least one of a second designated traffic identifier (TID) value or one or more second sets of QoS characteristics information that the network device is applying to the second data flow (as depicted by step 625 of FIG. 6). The STA may transmit a third SCS request to the network device, to adjust the at least one of the second designated traffic identifier (TID) value or the one or more second sets of QoS characteristics information for the second data flow (as depicted by step 645 of FIG. 6).

In some embodiments, the STA may indicate a support for receiving the SCS request from the network device via a capability field in a management frame, and the network device may indicate a support for sending the SCS request to the STA via a capability field in a management frame.

In some embodiments, the data flow may comprise an uplink data flow transmitted from the STA to the network device. In some embodiments, the data flow may comprise a downlink data flow transmitted from the network device to the STA.

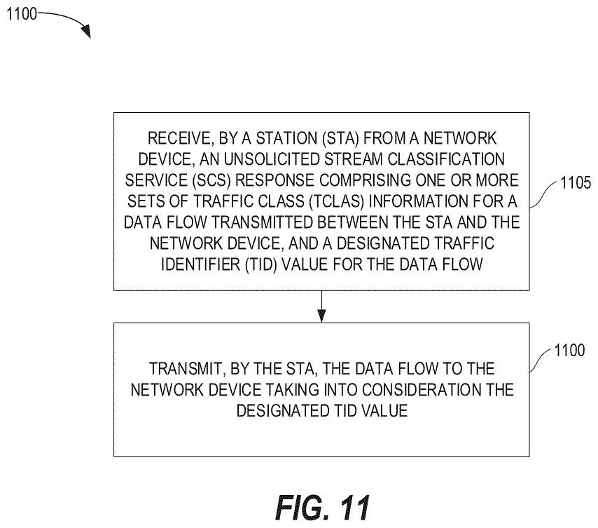

FIG. 11 is a flow diagram depicting an example method 1100 for SCS negotiation with unsolicited SCS responses, according to some embodiments of the present disclosure.

At block 1105, a STA (e.g., 510 of FIG. 5) receives an unsolicited Stream Classification Service (SCS) response from a network device (e.g., 505 of FIG. 5), comprising one or more sets of traffic class (TCLAS) information for a data flow transmitted between the STA and the network device, and a designated traffic identifier (TID) value for the data flow (as depicted by step 520 of FIG. 5).

At block 1110, the STA transmit the data flow to the network device taking into consideration the designated TID value (as depicted by steps 525 and 535 of FIG. 5).

In some embodiments, the unsolicited SCS response may further comprise one or more sets of QoS characteristics information for the data flow. In some embodiments, the unsolicited SCS response may further comprise a status field indicating that a mapping between the one or more sets of TCLAS information and at least one of the designated TID or the one or more sets of QoS characteristics information is mandatory to follow by the STA or a suggestion that is optional to follow by the STA.

In some embodiments, the STA may transmit the data flow to the network device taking into consideration at least one of the designated TID or the one or more sets of QoS characteristics information, if the mapping is indicated as mandatory in the unsolicited SCS response, or the STA may transmit the data flow optionally taking into consideration at least one of the designated TID or the one or more sets of QoS characteristics information, if the mapping is indicated as optional in the unsolicited SCS response.

In some embodiments, the STA may receive a second unsolicited SCS response from a network device, comprising one or more second sets of TCLAS information for a second data flow transmitted from the STA to the network device, and a second designated TID value for the second data flow (as depicted by step 520 of FIG. 5). The STA may determine that the designated TID for the second data flow does not align with one or more device settings of the STA (as depicted by step 530 of FIG. 5). The STA may terminate an SCS session initiated by the second unsolicited SCS response.

In some embodiments, the STA may indicate a support for receiving the unsolicited SCS response from the network device via a capability field in a management frame, and the network device may indicate a support for sending the unsolicited SCS response to the STA via a capability field in a management frame.

In some embodiments, the data flow may comprise an uplink data flow transmitted from the STA to the network device. In some embodiments, the data flow may comprise a downlink data flow transmitted from the network device to the STA.

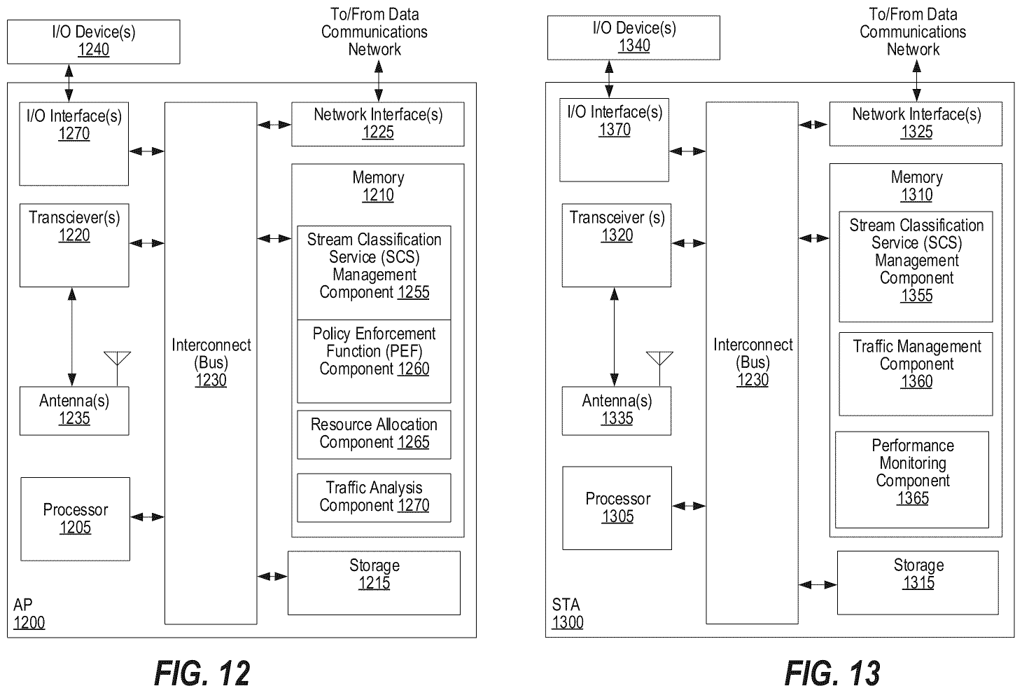

FIG. 12 depicts an example network device configured to perform various aspects of the present disclosure, according to some aspects of the present disclosure. In some embodiments, the example network device 1200 may correspond to APs 105 or WLC 155 as depicted in FIG. 1, AP/WLC 405 as depicted in FIG. 4, AP/WLC 505 as depicted in FIG. 5, or AP/WLC 605 as depicted in FIG. 6.

As illustrated, the example network device 1200 includes a processor 1205, memory 1210, storage 1215, one or more transceivers 1220, one or more I/O interfaces 1280, and one or more network interfaces 1125. In some embodiments, I/O devices 1240 are connected via the I/O interface(s) 1280. Further, via the network interface 1225, the network device 1200 can be communicatively coupled with one or more other devices and components (e.g., via a network, which may include the Internet, local network(s), and the like). Each of the components is communicatively coupled by one or more buses 1230. In some embodiments, one or more antennas 1235 may be coupled to the transceivers 1220 for transmitting and receiving wireless signals.

The processor 1205 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1205 processes information received through the transceiver 1220, I/O interfaces 1280, and the network interfaces 1225. The processor 1205 retrieves and executes programming instructions stored in memory 1210, as well as stores and retrieves application data residing in storage 1215.

The storage 1215 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1215 may store a variety of data for the efficient functioning of the system.

The memory 1210 may include random access memory (RAM) and read-only memory (ROM). The memory 1210 may store processor-executable software code containing instructions that, when executed by the processor 1205, enable the network device 1200 to perform various functions described herein for wireless communication. In the illustrated example, the memory 1210 includes four software components: SCS management component 1255, policy enforcement function (PEF) component 1260, resource allocation component 1165, and traffic analysis component 1270.

In some embodiments, the SCS management component 1255 may be configured to handle SCS requests and responses. The SCS management component 1255 may extract and analyze the TCLAS and QoS parameters provided in the SCS requests (as depicted by step 415 of FIG. 4). The SCS management component 1255 may route the extracted parameters to the PEF component 1260 to assess whether the preferred TID specified in the request aligns with the current network policies. If aligned, the SCS management component 1255 may proceed to manage the process to send an SCS response approving the preferred TID (as depicted by step 435 of FIG. 4). If not aligned, the SCS management component 1255 may generate an SCS response with a counterproposal (as depicted by step 445 of FIG. 4). In some embodiments, the counterproposal may include narrowing or broadening the range of IP addresses, port numbers, or modifying other identifiers to better fit the network's policies to handle the traffic appropriately. The counterproposal may further propose a different TID that can better accommodate the current TCLAS range. In some embodiments, the SCS management component 1255 may send unsolicited SCS responses to STAs to manage network resources more dynamically, even before the STA has made a request (as depicted by step 515 of FIG. 5). The SCS response may include TCLAS and/or QoS parameters for one or more UL/DL traffic flows, and a TID assigned by the network device to handle these specified flows. In some embodiments, a new field may be included within the unsolicited SCS response, which indicates whether the STAs must comply with the designated mappings or if the compliance is optional. In some embodiments, the SCS management component 1255 may include the TCLAS and/or QoS parameters, as well as the designated TID within an SCS request (as depicted by step 615 of FIG. 6). The STA may then evaluate the proposed TCLAS-to-TID mapping and send corresponding SCS responses.

In some embodiments, the PEF component 1260 may be configured to receive the extracted parameters provided in SCS requests (from the SCS management component 1255), such as TCLAS information and QoS characteristics, to determine the service type and/or even the specific application that the UL/DL traffic flows are serving. Based on the classification, the PEF component 1260 may evaluate whether the preferred TID (requested by the STA) is justified under the currently established network policies or service agreements.

In some embodiments, the resource allocation component 1265 may allocate the network resources required to set up SCS streams according to an agreed-on TCLAS-to-TID mapping once the negotiation is completed.

In some embodiments, the traffic analysis component 1270 may monitor and analyze network traffic patterns to provide real-time data to the SCS management component 1255 and resource allocation component 1265.

Although depicted as a discrete component for conceptual clarity, in some embodiments, the operations of the depicted components (and others not illustrated) may be combined or distributed across any number of components. Further, although depicted as software residing in memory 1210, in some aspects, the operations of the depicted components (and others not illustrated) may be implemented using hardware, software, or a combination of hardware and software.

FIG. 13 depicts an example client device 1300 configured to perform various aspects of the present disclosure, according to some embodiments of the present disclosure. In some embodiments, the example client device 1300 may correspond to STAs 110 as depicted in FIG. 1, STA 410 as depicted in FIG. 4, STA 510 as depicted in FIG. 5, or STA 510 as depicted in FIG. 5.

As illustrated, the example client device 1300 includes a processor 1305, memory 1310, storage 1315, one or more transceivers 1320, one or more I/O interfaces 1380, and one or more network interfaces 1325. In some embodiments, I/O devices 1340 are connected via the I/O interface(s) 1380. Further, via the network interface 1325, the client device 1300 can be communicatively coupled with one or more other devices and components (e.g., via a network, which may include the Internet, local network(s), and the like). Each of the components is communicatively coupled by one or more buses 1330. In some embodiments, one or more antennas 1335 may be coupled to the transceivers 1320 for transmitting and receiving wireless signals.

The processor 1305 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1305 processes information received through the transceiver 1320, I/O interfaces 1370, and the network interfaces 1325. The processor 1305 retrieves and executes programming instructions stored in memory 1310, as well as stores and retrieves application data residing in storage 1315.

The storage 1315 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1315 may store a variety of data for the efficient functioning of the system.

The memory 1310 may include random access memory (RAM) and read-only memory (ROM). The memory 1310 may store processor-executable software code containing instructions that, when executed by the processor 1305, enable the client device 1300 to perform various functions described herein for wireless communication. In the illustrated example, the memory 1310 includes three software components: the SCS management component 1355, traffic management component 1360, and the performance monitoring component 1365. In some embodiments, the SCS management component 1355 may generate SCS requests based on local application needs and user inputs, and processing incoming SCS requests or responses from the associated AP. The SCS component 1355 may further evaluate whether the TID assigned by the AP can be adopted, considering the device's configurations and operational constraints. In some embodiments, the traffic management component 1360 may manage the sending of UL/DL traffic using either the established SCS streams or default SCS streams, based on the current network policies and the negotiation service quality levels. In some embodiments, the performance monitoring component 1365 may monitor and track network performance parameters, such as latency, packet loss, and jitter, to assess the quality of the network connection and provide feedback to the AP or WLC as necessary.

Although depicted as a discrete component for conceptual clarity, in some embodiments, the operations of the depicted components (and others not illustrated) may be combined or distributed across any number of components. Further, although depicted as software residing in memory 1310, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a network device from an associated station (STA), a Stream Classification Service (SCS) request comprising one or more sets of traffic class (TCLAS) information and a preferred traffic identifier (TID) value for a data flow transmitted between the STA and the network device;
determining, by the network devices, a type of service of the data flow by analyzing the one or more sets of TCLAS information;
confirming, by the network device, that the type of service does not align with the preferred TID value under one or more defined network policies; and
in response to the confirmation, sending, by the network device to the STA, an SCS response comprising adjustments of at least one of the one or more sets of TCLAS information or the preferred TID value to a new TID value.

2. The method of claim 1, wherein the data flow comprises an uplink data flow transmitted from the STA to the network device.

3. The method of claim 1, wherein the data flow comprises a downlink data flow transmitted from the network device to the STA.

4. The method of claim 1, further comprising:
receiving, by the network device, a second SCS request from the STA incorporating the adjustments;
confirming, by the network device, that the adjusted one or more sets of TCLAS information align with the preferred TID value under the one or more defined network policies;
allocating, by the network device, network resources to the data flow per the preferred TID value; and
sending, by the network device, a second SCS response confirming the preferred TID value.

5. The method of claim 1, further comprising:
receiving, by the network device, a second SCS request from the STA incorporating the adjustments;
confirming, by the network device, that the one or more sets of TCLAS information align with the new TID value under the one or more defined network policies;
allocating, by the network device, network resources to the data flow per the new TID value; and
sending, by the network device, a second SCS response confirming the new TID value.

6. The method of claim 1, wherein the SCS request further comprises one or more sets of quality of service (QoS) characteristics information for the data flow, and wherein determining the type of service of the data flow comprises analyzing both the one or more sets of TCLAS information and the one or more sets of quality of service (QoS) characteristics information.

7. The method of claim 6, further comprising sending, by the network device to the STA, adjustments of the one or more sets of QoS characteristics information for the data flow in the SCS response.

8. The method of claim 1, further comprising sending, by the network device to the STA, a failure status code in the SCS response if the one or more sets of TCLAS information are not included for the data flow.

9. The method of claim 1, wherein each set of the one or more sets of TCLAS information comprises at least one of 5-tuple data, an application ID, or a web address or a fully qualified domain name (FQDN).

10. The method of claim 6, wherein each set of the one or more sets of QoS characteristics information comprises at least one of a service interval, delay bound, burst size, or minimum data rate.

11. The method of claim 1, wherein the adjustments of the one or more sets of TCLAS information comprise at least one of:
narrowing a scope of the one or more sets of TCLAS information, comprising limiting, by the network device, a range of IP addresses, port numbers, or port types to the preferred TID; or
broadening the scope of the one or more sets of TCLAS information, comprising expanding, by the network device, the range of IP addresses, port numbers, or protocol types to the preferred TID.

12. The method of claim 1, wherein the network device comprises at least one of an access point (AP), a wireless local area network controller (WLC), a network security appliance, or a gateway.

13. The method of claim 1, wherein the STA or the network device indicates a support for at least one of TCLAS inclusion for uplink data flows, TCLAS negotiation, or preferred TID negotiation via a capability field in a management frame.

14. A method, further comprising:
receiving, by a station (STA) from a network device, a Stream Classification Service (SCS) request comprising one or more sets of traffic class (TCLAS) information for a data flow transmitted from the STA to the network device, and a designated traffic identifier (TID) value for the data flow;
confirming, by the STA, in an SCS response sent to the network device, that the designated TID value can be adopted for handling the data flow considering one or more device settings of the STA; and
in response to the confirmation, transmitting, by the STA, the data flow to the network device taking into consideration the designated TID value.

15. The method of claim 14, wherein the SCS request further comprises one or more sets of QoS characteristics information for the data flow, and an indication that the one or more sets of QoS characteristics information can be considered for transmitting the data flow.

16. The method of claim 15, wherein the SCS request further comprises a field indicating whether adopting at least one of the designated TID or the one or more sets of QoS characteristics information for the data flow is mandatory or optional to follow by the STA.

17. The method of claim 14, further comprising:
receiving, by the STA from a network device, a second SCS request comprising one or more second sets of TCLAS information for a second data flow transmitted from the STA to the network device, and a second designated TID value for the second data flow;
determining, by the STA, that the second designated TID value cannot be adopted for handling the second data flow considering the one or more device settings of the STA; and
sending, by the STA to the network device, a second SCS response rejecting the second SCS request.

18. The method of claim 14, further comprising:
receiving, by the STA from a network device, a second SCS request comprising one or more second sets of traffic class (TCLAS) information for a second data flow transmitted from the network device to the STA, and at least one of a second designated traffic identifier (TID) value or one or more second sets of QoS characteristics information that the network device is applying to the second data flow.

19. The method of claim 18, further comprises sending, by the STA to the network device, a third SCS request to adjust the at least one of the second designated traffic identifier (TID) value or the one or more second sets of QoS characteristics information for the second data flow.

20. The method of claim 14, wherein:
the STA indicates a support for receiving the SCS request from the network device via a capability field in a management frame, and
the network device indicates a support for sending the SCS request to the STA via a capability field in a management frame.

21. A method, further comprising:
receiving, by a station (STA) from a network device, an unsolicited Stream Classification Service (SCS) response comprising one or more sets of traffic class (TCLAS) information for a data flow transmitted between the STA and the network device, and a designated traffic identifier (TID) value for the data flow; and
transmitting, by the STA, the data flow to the network device taking into consideration the designated TID value.

22. The method of claim 21, wherein the unsolicited SCS response further comprises one or more sets of QoS characteristics information for the data flow.

23. The method of claim 22, wherein the unsolicited SCS response further comprises a status field indicating that a mapping between the one or more sets of TCLAS information and at least one of the designated TID or the one or more sets of QoS characteristics information is mandatory to follow by the STA or a suggestion that is optional to follow by the STA.

24. The method of claim 23, further comprising:
transmitting, by the STA, the data flow to the network device taking into consideration at least one of the designated TID or the one or more sets of QoS characteristics information, if the mapping is indicated as mandatory in the unsolicited SCS response, or
transmitting, by the STA, the data flow optionally taking into consideration at least one of the designated TID or the one or more sets of QoS characteristics information, if the mapping is indicated as optional in the unsolicited SCS response.

25. The method of claim 21, further comprising:
receiving, by the STA from a network device, a second unsolicited SCS response comprising one or more second sets of TCLAS information for a second data flow transmitted from the STA to the network device, and a second designated TID value for the second data flow;
determining, by the STA, that the designated TID for the second data flow does not align with one or more device settings of the STA; and
terminating, by the STA, an SCS session initiated by the second unsolicited SCS response.

26. The method of claim 21, wherein:
the STA indicates a support for receiving the unsolicited SCS response from the network device via a capability field in a management frame, and
the network device indicates a support for sending the unsolicited SCS response to the STA via a capability field in a management frame.
